(19) United States
(12) Patent Application Publication
(10) Pub. No.: US 2016/0209219 A1
(43) Pub. Date: Jul. 21, 2016

(54) METHOD OF AUTONOMOUS LANE IDENTIFICATION FOR A MULTILANE VEHICLE ROADWAY

(71) Applicant: Applied Telemetrics Holdings Inc., Toronto (CA)

(72) Inventors: Bernard GRUSH, Toronto (CA); Roger D'HOLLANDER, London (CA); Joseph LEBLANC, Toronto (CA)

(21) Appl. No.: 14/598,038

(22) Filed: Jan. 15, 2015

(51) Int. Cl. G01C 21/34

(52) U.S. Cl. CPC G01C 21/34

(57) ABSTRACT

A method is provided for identifying a vehicle's lane of travel amongst a set of lanes in a roadway facility. This is needed for vehicle segregation management such as for lane-specific tolling or specified vehicle access. Signals are received from one or more signal sources at a receiver within, attached to or integrated into the vehicle. Using the received signals, an approximate path of travel of the vehicle is identified and it is determined whether the vehicle's approximate path of travel crosses a geofence or virtual gantry associated with at least one boundary region of the chargeable roadway facility. If the vehicle's approximate path of travel crosses the geofence, it is determined, using distance and speed measures, and with a calculated degree of certainty, whether the measured travel path is within the targeted lane of travel.

### FIELD OF THE INVENTION

The invention relates to roadway lane management, vehicle segregation by lane-use, charging methods and systems for vehicle tolling, and optimization of the charging performance of electronic tolling for a specific lane of travel.

### BACKGROUND OF THE INVENTION

For managing flow in traffic lanes, sometimes it is useful or desired to toll some traffic lanes, but not all. An example of this is to toll only a single lane on a multi-lane highway. Another example might be to toll several or all of the lanes, but at different rates. A third potential would be to permit the use of a bus lane by a private vehicle subject to a toll. A fourth potential is to segregate, count, or direct vehicles in lanes by vehicle type or other measure.

A well-known example is to convert a special purpose, High Occupancy Vehicle (HOV) lane to a High-Occupancy/Toll (HOT) lane or create a HOT lane into which low-occupancy vehicles are permitted subject to a toll.

A key issue for HOT lanes is the potential expense of a system to detect these users and to charge for use. This is exacerbated by the fact that these systems might toll only one or two lanes out of three or more, and that the lane(s) to be tolled still accommodate(s) the original, previously specified, non-paying vehicles. That means reduced capacity to accommodate tolled vehicles compared to a lane in which every vehicle is being tolled.

A critical concern is expense. How can a road authority or operator admit a controlled number of paying guest users (say single occupant vehicles) into a specific lane, and charge a toll for that use, with the absolute minimum expense. Using systems that require cameras, RFID readers, infrared sensors, or other similar sensing and detection systems requires expensive roadside infrastructure, such as hardened equipment mounted on gantries requiring power and maintenance.

Prior art for identifying specific lane of travel includes RFID “tag and beacon” or the equivalent “transponder and reader”. Video systems can be used to identify users within a lane by reading license plates. All of these require roadside infrastructure, and have associated costs that we wish to avoid.

There is also prior art that requires in-vehicle cameras and other techniques such as automated steering monitoring to help in lane guidance. These latter inventions are for keeping a car within a lane rather than identifying which lane the vehicle is in.

What is sought is a method of using in-vehicle telematics for the purpose of lane identification that is effective without roadside equipment and infrastructure. The method sought should have a high degree of accuracy with respect to “charging performance”. In other words, the system should make no, or almost no, errors of identification that would cause false charges and very few errors of missed charges. (Error management is described formally in the ISO Technical Standard ISO-17444-1, “Electronic fee collection—Charging performance—Part 1: Metrics”.)

Solving the problem of tolling a single lane from a set of lanes means special processing of data from in-vehicle telematics devices but subject to the tests set out in ISO-17444 in order to manage a very low error rate, and in particular a zero or near-zero false-charge rate.

U.S. Pat. No. 7,215,255 details a method and apparatus that comprises appropriate databases, wireless communication, and autonomous metering methods, combined with private, in-vehicle data services to provide a digital, location-based, in-car meter intended to address these kinds of issues. The '255 Patent outlines the basis of a system enabled to gather and manage detailed geographic information regarding the use of roadways in an electronic database associated with a location-aware, in-car telemetrics system in order to enable an intelligent, autonomous road-use meter that operates without human intervention. The apparatus described in '255 may be used to advantage in implementation of the present system and method. The '255 patent is incorporated herein by reference.

Unfortunately, positioning errors ranging up to a few tens of meters are common in automotive telemetry systems that use wireless radio-signal based positioning systems. Such systems can lead to lane uncertainty resulting in mischarging. It would be desirable to provide a method for optimizing the charging performance of in-vehicle lane identification systems, and thus make available new, lower-cost opportunities for lane-use tolling that arise from improved reliability without the use of roadside infrastructure.

The present application extends the previous road-use systems, including that described in the '255 patent, in order to identify payable lane-use events (more demanding than identifying road-use events) for automated payment and associated service offerings.

### SUMMARY OF THE INVENTION

The present method and system are directed at honing the geographic location of a vehicle to enable an in-vehicle, lane-identification system for lane-use management purposes, including charging for lane use. The method and system aim to improve charging performance by addressing certain radio-signal based positioning errors which may occur for any positioning technology such as GNSS, Cell-tower or WiFi or equivalent, particularly within urban environments or other forms of harsh signal terrain that is antithetical to reliable location determination using radio technologies. The method and system presented here will also improve autonomous lane identification on open highways, where “autonomous” means “without the use of roadside equipment or infrastructure”.

A method is provided for charging a user for using a vehicle within a specific lane of a roadway. Signals are received from one or more signal sources at a receiver within, attached to, or integrated into the vehicle. Using the received signals, an approximate path of travel of the vehicle is identified and it is determined whether the vehicle's approximate path of travel crosses a geofence associated with at least one boundary region of the chargeable roadway facility. If the vehicle's approximate path of travel crosses the geofence, then detailed point-by-point position data is collected and filtered until such time that the vehicle's approximate path exits said geofence. This detailed point-by-point position data can be collected many times per second or once every many seconds. The frequency of collection is circumstance-specific and may be related to speed or may be critical to the efficacy of an instance of the system.

This detailed point-by-point position data is then compared to the detailed centerline data of the target lane as well as to the centerline(s) of each adjacent lane using a distance metric sampled at the same frequency as each sampled travel point or at any sampling or resampling frequency suitable to the level of error in the received telemetry data. Hence the travel record (detailed point-by-point position data), including any positioning errors it may contain, will have a large number of associated proximity measures along a road segment for each of at least two potential lanes of travel—the target or chargeable lane and the lane(s) adjacent to it. (A road segment is a pre-defined length of road, typically between access ramps or intersections.)

Depending on vehicle speed, length of road segment being assessed, and sampling frequency, the number of proximity measures may range from several tens to many hundreds or more. These measures are used to generate a likelihood of travel within each of the lanes compared. These likelihood measures can pertain to a single subset of measured points or to a consecutive series of subsets of any length including the entire road segment length. Thresholds can be set based on prior calibration or on real-time context and a final assessment of whether the vehicle is or was traveling in the targeted lane can be made. Any number of subset assessments can be aggregated and weighted for an entire length of roadway segment, if desired, and a charge or use-fee can be determined from that assessment.

In an alternative implementation, likelihood measures can be assessed for arbitrary portions of the road segment in the event of specialized lanes that are not grade-separated, so that vehicles entering and leaving the target lane(s) in mid road segment can be assessed distinctly from a vehicle that remains within the intended lane throughout the road segment the traveler is using.

### BRIEF DESCRIPTION OF THE DRAWINGS

The invention is described below in detail with reference to the accompanying drawings in which:

FIG. 1 illustrates an idealized road segment between two intersections or entry/exit ramps. Road segments need not be a straight line and can take on any arbitrary curvature.

FIG. 2 illustrates an arbitrary close-up section of road segment with multiple lanes, lane boundaries, lane centerlines and a vehicle travel path.

FIG. 3 illustrates the measurement of distance from one sample point to nearby lane centerlines.

FIG. 4 illustrates the use of differential speed to bolster the likelihood calculation used to determine whether a specific lane was used.

### DETAILED DESCRIPTION

When using telemetric location methods such as GNSS, cell-tower or WiFi or equivalent, particularly within urban environments or other forms of harsh signal terrain, it is well known that errors of a few or several meters are common. These errors are often mitigated with application-specific equipment or application specific processing for specific contexts.

In the case of this invention—lane identification within a multilane vehicle roadway—vehicles may be segregated by type (bus, truck, hazardous goods, car), occupancy (single occupant, multi-occupant), or by usage fee (toll or no toll) or other combination or distinction. FIG. 4 shows an instance of this for free lanes 41 versus high occupancy/toll lanes 42. This invention is useful for high occupancy/toll (“HOT”) contexts, but it is not restricted to tolling applications. On the contrary, it can be applied in other traffic, travel and infrastructure management applications.

The present method and system uses autonomous location information gathered by equipment within a vehicle about that vehicle and its travel context within a roadway to determine its lane of travel, often for, but not restricted to, the purpose of tolling said vehicle for the use of that lane. This method and system aim to improve charging performance by addressing location errors which may occur for any positioning technology such as GNSS, cell-tower or WiFi or equivalent, particularly within urban environments or other forms of harsh signal terrain that may generate random and/or transient location errors when using these technologies. The method and system presented here will also improve autonomous lane identification on open highways, where “autonomous” means “without the use of roadside infrastructure”.

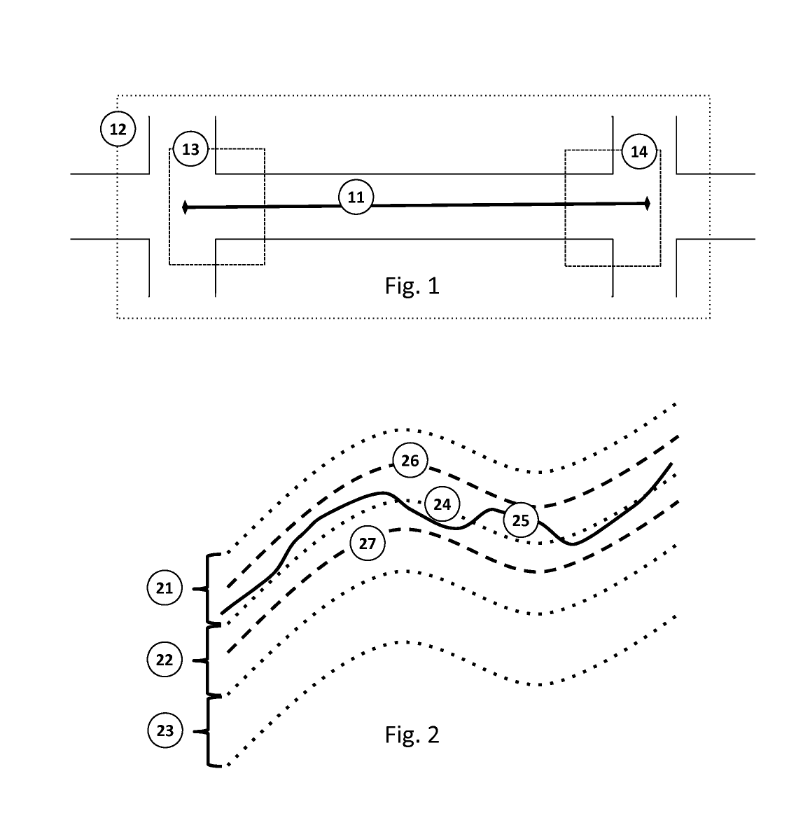

The following lane identification method is provided to identify when a vehicle is being used within a specific lane of a roadway. Signals are received from one or more signal sources at a receiver within, attached to, or integrated into the vehicle. Using the received signals, an approximate path of travel of the vehicle is gathered and it is determined whether the vehicle's path of travel crosses a geofence associated with at least one boundary region of the chargeable roadway facility. In FIG. 1 a road segment 11 includes at least two lanes types to be distinguished. This road segment is bounded by an inclusive geofence 12, such that a vehicle must be within this geofence to be considered as a candidate for the lane identification system. This geofence 12 reduces computation. Road segment 11 is marked with virtual gantries at its beginning 13 and end 14 such that when entered or crossed using any geometric calculation including any of the virtual gantry-crossing techniques taught in US 20140236686 A1 (incorporated herein by reference), the subject lane identification algorithm may commence or cease, respectively. The use of virtual gentries 13, 14 is for the constrained case of controlled access when a vehicle cannot enter or exit a roadway segment except at the intersection or ramp near these gantries 13, 14. Alternatively, for the case of a roadway that maybe entered or exited arbitrarily along its length crossing the geofence 12 is used to begin and end the lane identification algorithm.

While the lane identification algorithm is operating within the geofence 12 or between the virtual entry 13 and virtual exit 14 gantries, there will be at least one special purpose or “target” lane (toll, bus, high occupancy) and at least one other “general” lane. FIG. 2 is a close up view of a small part of the full road segment 11 and illustrates three lanes of travel proceeding in one direction. One lane 21 is a target lane restricted to specific vehicles, for example, high-occupancy or toll-paying vehicles. Two other lanes 22, 23 are general purpose and are not restricted by use. The special purpose or target lane may be separated by a barrier, but in the general case addressed here, it may be marked only by a painted or slightly raised line or a rumble strip 24. When a subject vehicle uses any of these lanes 21, 22, 23, that vehicle generates a trip record 25 from its on-board location apparatus. That trip record contains position and speed estimates among other possible elements, multiple times per second or once every few seconds.

Associated with each such roadway lane is an engineering specification or equivalent for the centerline of the lane. In FIG. 2 is shown the centerline 26 for the special lane 21 as well as the centerline 27 for the general lane 22 adjacent to it. These centerline specifications will be invariable and highly accurate relative to the trip record 25. In contrast, the trip record 25 will be slightly different for each trip on this segment since trip records almost always contain at least minor positional variances (inaccuracies).

After the vehicle's approximate path of travel crosses the geofence 12, in the case of a road segment without restricted access or after the approximate path of travel crosses the virtual gantry 13 in the case of a road segment with restricted access, the detailed point-by-point position data of the trip record 25 is collected and filtered by any means useful to remove signal noise until such time that the vehicle's trip record exits the geofence 12 or crosses the virtual exit gantry 14, respectively. This detailed point-by-point position data can be collected many times per second or once every many seconds. The frequency of collection is circumstance-specific and may be related to speed or may be critical to the efficacy of an instance of the system.

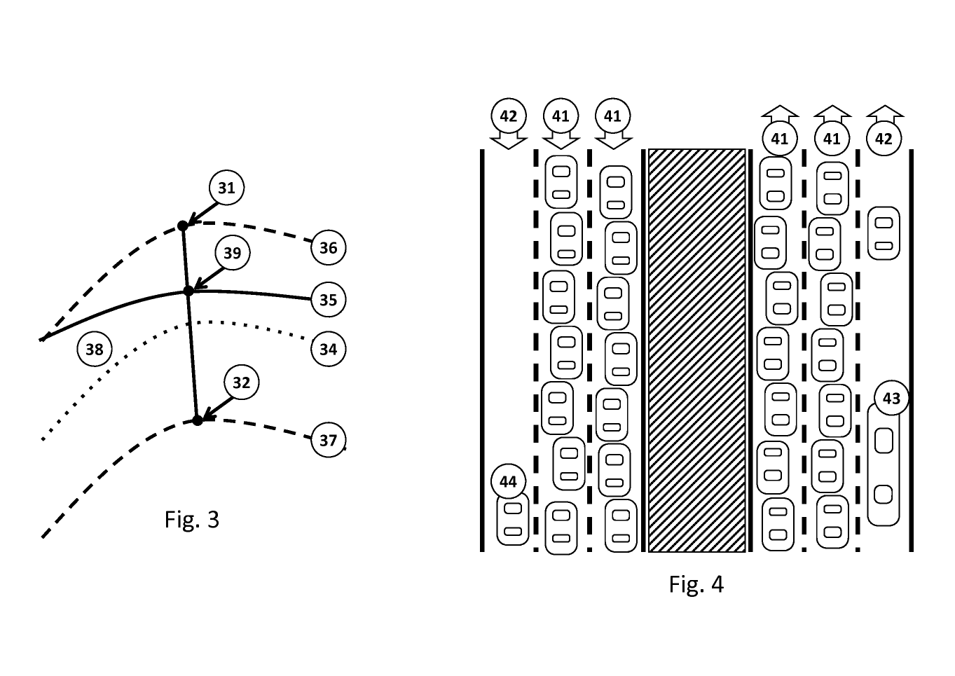

Referring to FIG. 3, this further detailed point-by-point position data 35 (same as or derived from the trip record 25) is then compared to the detailed centerline data of the target lane 36, 26 as well as that of each adjacent lane 37, 27 using a distance metric sampled at the same frequency as each sampled travel point or at any sampling or resampling frequency suitable to the level of error in the received data 35. Hence the detailed point-by-point position data 35, 25—including any positioning errors it may contain will have a large number of associated proximity measures along the road segment for each of at least two potential lanes of travel—the special purpose lane and the general purpose lane(s) adjacent to it. As an example, the data point 39 in the trip data 35 has a distance to point 31 in centerline 36 and a distance to a point 32 in centerline 37. There are well-known ways to measure these distances. To ensure generality, this method can include a point-by-point distance comparison with each centerline of every lane within the road segment. Each of these comparisons will have an associated likelihood to aid in the identification of lane used.

Depending on vehicle speed, length of road segment being assessed, and sampling frequency, the number of proximity measures may range from several tens to many hundreds. These measures are used to generate a likelihood of travel within each lanes compared. These likelihood measures can pertain to single sample points, to subsets of several samples points each, as a weighted sum for the entire length of road segment, or as a combination of these approaches. Many small assessments can be aggregated and weighted for an entire length of roadway segment. Likelihood thresholds can be set based on prior calibration or on real-time context and used to make a final assessment of whether the vehicle was traveling in a special lane or a general lane and a charge. A charge, toll, user-fee or other management decision can be determined from that assessment.

In an alternative implementation, likelihood measures can be assessed for arbitrary portions of the road segment in the case of no barrier separating the special lane(s) so that vehicles entering and leaving the special lane(s) mid road-segment can be assessed distinctly from a vehicle that remains within the intended lane throughout the road segment being measured.

As a further aid to assessing the likelihood of travel in a special lane or a general-purpose lane it is possible to employ speed information. In the case of congestion management schemes such as high occupancy/toll lanes FIG. 4, during the time of scheduled tolling it is typical and expected that the special purpose lanes 42 will be traveling somewhat faster than the general-purpose lanes 41. Speed information for the subject vehicle 44 is available from its trip record, while speed information about the vehicles in the general-purpose lanes 41 is available from a number of services that capture this information wirelessly using cellular data and other techniques, including even historical daily speed patterns. Such a speed differential may be used to promote, diminish or confirm the computed likelihood measure. Such speed comparisons are often critical anyway to insure lane performance for the special-purpose lanes.

The geofence may be one of:

a virtual gantry or a set of virtual gantries predetermined to capture the vehicle's passage or entry to the road segment containing the targeted, specific lane to be identified, and crossing that geofence triggers the process of specific lane identification. This is for the case of a limited access road segment that can only be entered at a specific intersection(s) or ramp(s); and

a virtual gantry surrounding the entire road segment for the same purpose, but allowing entry at any point along the segment. This is for the case of a general road segment that might be entered at any arbitrary location along its length.

Where virtual gantries are used, the step of determining if the vehicle's approximate path of travel crosses a geofence may comprise the direction of crossing the virtual gantry.

Where bounding polygons are used as virtual gantries, the bounding polygon may be approximated with a bounding rectangle.

In one embodiment, the signal source is a satellite positioning receiver/transmitter. The receiver/transmitter may be a portable device or a device fixed in the vehicle.

In certain embodiments, the signal source (or at least part of its functionality) may be provided by a user's mobile device.

In certain embodiments, the signal source (or at least part of its functionality) may be provided by an in-dash positioning system.

In one embodiment, the signal source has receiving and transmitting components in separate physical devices that are in communication with each other.

1. A method of identifying the lane of travel of a vehicle for controlling, managing or charging for using a vehicle in a particular lane or lanes(s) of a tolled/segmented roadway, the method comprising:
receiving signals from at least one signal source at a receiver within, attached to or integrated into the vehicle;
using the received signals to identify an approximate path of travel of the vehicle;
detecting if the vehicle's approximate path of travel crosses a geofence associated with at least one boundary region of the tolled/segmented roadway;
if the vehicle's approximate path of travel crosses the geofence, receiving a detailed travel path of the vehicle and determining, with a degree of certainty, whether the vehicle's detailed travel path has used a specified roadway lane associated with that geofence.

2. The method of claim 1, wherein the determining step further comprises determining the portion of road segment distance said vehicle used the specified roadway lane.

3. The method of claim 1, wherein the determining step further comprises checking whether the vehicle's speed is consistent with the use of that same specific, tolled/segmented roadway lane.

4. The method of claim 2, further comprising:
if the vehicle is determined to have traveled in the specified roadway lane, associating that trip segment with a charge or access permission; and
assessing the charge or issuing a permission credential to the user.

5. The method of claim 1, wherein the geofence comprises:
a virtual gantry predetermined to approximately define an entry into the tolled/segmented roadway, and crossing the geofence comprises travelling into or through the virtual gantry.

6. The method of claim 1, wherein the geofence comprises:
a bounding polygon predetermined to approximately define a perimeter around the tolled/segmented roadway facility; or
at least one bounding polygon predetermined to approximately define a perimeter around the entry to or exit from a tolled/segmented roadway facility.

7. The method of claim 1, wherein if the degree of certainty is above a threshold such that the vehicle's detailed travel path has used a specified roadway lane associated with that geofence, a charge can be assessed or a permission credential issued.

8. The method of claim 1, wherein the determining step comprises applying a decision algorithm which compares the signals received to the fixed geometric centerline of the intended or claimed lane of travel.

9. The method of claim 1, wherein the determining step comprises applying a decision algorithm which compares the speed taken from the at least one signal source to the speed to be expected or reported when using the targeted lane of travel.

10. The method of claim 1, wherein the determining step comprises applying a decision algorithm which includes:
weighing a probability that the travel path lies within the targeted lane, having regard to at least one factor selected from the group consisting of:
the location of the chargeable lane;
the permitted direction(s) of travel for the use of the chargeable lane; or
the vehicle's approximate path of travel prior entry into the road segment containing the chargeable lane, including the use of any information from any source derived from location signals, acceleration data, gyroscopic sensors, speed data, inertial calculations, any other heading calculations on any or all three of the X, Y and Z axes, noise removal, statistical methods, signal filtering or weighting, past history of data corrections, or knowledge of man-made or earth surface features in the area of the vehicle's approximate path of travel.

11. The method of claim 1, wherein the signal source is a satellite positioning receiver/transmitter.

12. The method of claim 11, wherein the receiver/transmitter is a portable device.

13. The method of claim 11, wherein the receiver/transmitter is a device fixed in or on the vehicle.

14. The method of claim 1, wherein the signal source is a user's mobile device.

15. The method of claim 1, wherein the signal source is an in-dash positioning system.

16. The method of claim 1, wherein the signal source has receiving and transmitting components in separate physical devices that are in communication with each other.
